(19) United States
(12) Patent Application Publication
(10) Pub. No.: US 2016/0311612 A1
(43) Pub. Date: Oct. 27, 2016

(54) MOBILE TRANSFER STATION FOR FLOWABLE MATERIAL

(71) Applicant: Ozinga Ready Mix Concrete, Inc., Mokena, IL (US)

(72) Inventor: Justin A. Ozinga, Frankfort, IL (US)

(21) Appl. No.: 15/089,663

(22) Filed: Apr. 4, 2016

Related U.S. Application Data
(60) Provisional application No. 62/151,668, filed on Apr. 23, 2015.

(51) Int. Cl. B65D 88/30; B28C 7/16

(52) U.S. Cl. CPC B65D 88/30; B28C 7/168

(57) ABSTRACT

A mobile transfer station for flowable material includes a mobile frame defining a footprint. A hopper support is pivotally coupled to the mobile frame and a hopper is pivotally coupled to the hopper support. A valve is disposed in a lower portion of the hopper. A chute is slidably coupled to the hopper and disposed beneath the valve. The chute is extendable from a first position within the mobile frame's footprint to a second position where chute's outboard end is outside the mobile frame's footprint. A lift mechanism is coupled to the mobile frame and the hopper support for raising and lowering the hopper relative to the mobile frame.

Pursuant to 35 U.S.C. §119, the benefit of priority from provisional application 62/151,668, with a filing date of Apr. 23, 2015, is claimed for this non-provisional application.

### FIELD OF THE INVENTION

The invention relates generally to material handling, and more particularly to a mobile transfer station that facilitates the transfer of a flowable material such as concrete from dump trucks to ready mix trucks at a job site.

### BACKGROUND OF THE INVENTION

Wet or plastic concrete is delivered to a job site by a ready mix truck or by a dump truck. Both types of trucks have their advantages and disadvantages. Ready mix trucks simultaneously mix and transport wet concrete to a job site. A ready mix truck can be loaded with pre-mixed materials or dry materials and water. In either case, the materials are maintained in a liquid state as the ready mix truck's drum is rotated. Once at the job site, ready mix trucks disperse the wet concrete in a fairly precise fashion where it is needed via a chute. Unfortunately, the cost and frequent limited-availability of ready mix trucks can negatively impact a job's budget and production schedule.

Using dump trucks to deliver wet concrete to a job site provides several advantages compared to the use of ready mix trucks. First, dump trucks have a greater payload than ready mix trucks. Second, dump trucks are plentiful in the marketplace thereby generally assuring sufficient availability even for large jobs. Third, dump trucks are less expensive to own/operate than ready mix trucks thereby making them preferable from a cost perspective. However, dump trucks are not equipped for the precise dispensing of wet concrete thereby complicating their use at a job site. Furthermore, dump trucks are not equipped for adjusting or mixing a concrete mixture while the concrete is being transported. As a result, the viscosity changes experienced by wet concrete being transported by dump trucks to a job site can negatively impact the concrete's workability during placement at the job site.

### SUMMARY OF THE INVENTION

Accordingly, it is an object of the present invention to provide an apparatus that facilitates transfer of a bulk flowable material such as wet concrete to improve handling operations.

Another object of the present invention is to provide an apparatus that facilitates the use of dump trucks for delivery of wet concrete to a job site.

Still another object of the present invention is to provide an apparatus that can readily be transported to a job site to facilitate efficient wet concrete delivery to the job site and wet concrete dispensing at the job site.

Other objects and advantages of the present invention will become more obvious hereinafter in the specification and drawings.

In accordance with the present invention, a mobile transfer station for flowable material includes a mobile frame defining a footprint. A hopper support has a first end and a second end with the first end being pivotally coupled to the mobile frame. An open-top hopper is pivotally coupled to the second end of the hopper support. A valve is disposed in a lower portion of the hopper. A chute is slidably coupled to the hopper and disposed beneath the valve. The chute has an upper end and a lower end wherein the upper end is maintained at a height that is greater than a height of the lower end. The chute is extendable from a first position to a second position wherein the chute's lower end is within the mobile frame's footprint when the chute is in its first position, and wherein the chute's lower end is outside the mobile frame's footprint when the chute is in its second position. A lift mechanism is coupled to the mobile frame and a portion of the hopper support between its first end and second end for raising and lowering the hopper relative to the mobile frame.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a perspective view of a mobile transfer station in a transport-ready configuration in accordance with an embodiment of the present invention;

FIG. 2 is a top plan view of the mobile transfer station in its transport-ready configuration;

FIG. 3 is a perspective view of the mobile transfer station in a site-ready configuration;

FIG. 4 is a top plan view of the mobile transportation in its site-ready configuration;

FIG. 5 is an isolated perspective view of the hopper support in accordance with an embodiment of the present invention;

FIG. 6 is an isolated perspective view of the hopper and chute assembly in accordance with an embodiment of the present invention;

FIG. 7 is an isolated perspective view of the chute;

FIG. 8 is an isolated end view of the hopper and chute assembly with the chute extended and opened for a concrete off-loading operation;

FIG. 9 is a perspective view of the mobile transfer station with its hopper deflector in a tilted configuration in preparation for receiving a flowable material;

FIG. 10 is a perspective view of the mobile transfer station with its hopper assembly raised in preparation for off-loading of a flowable material;

FIG. 11 is a perspective view of the mobile transfer station with its chute extended in preparation for off-loading of a flowable material;

FIG. 12 is a perspective view of the mobile transfer station with its chute extended and opened as it would be during the off-loading of a flowable material; and

FIG. 13 is a side view of a ready mix truck positioned to receive concrete when the mobile transfer station's chute is extended and opened for the off-loading of concrete into a ready mix truck.

### DETAILED DESCRIPTION OF THE INVENTION

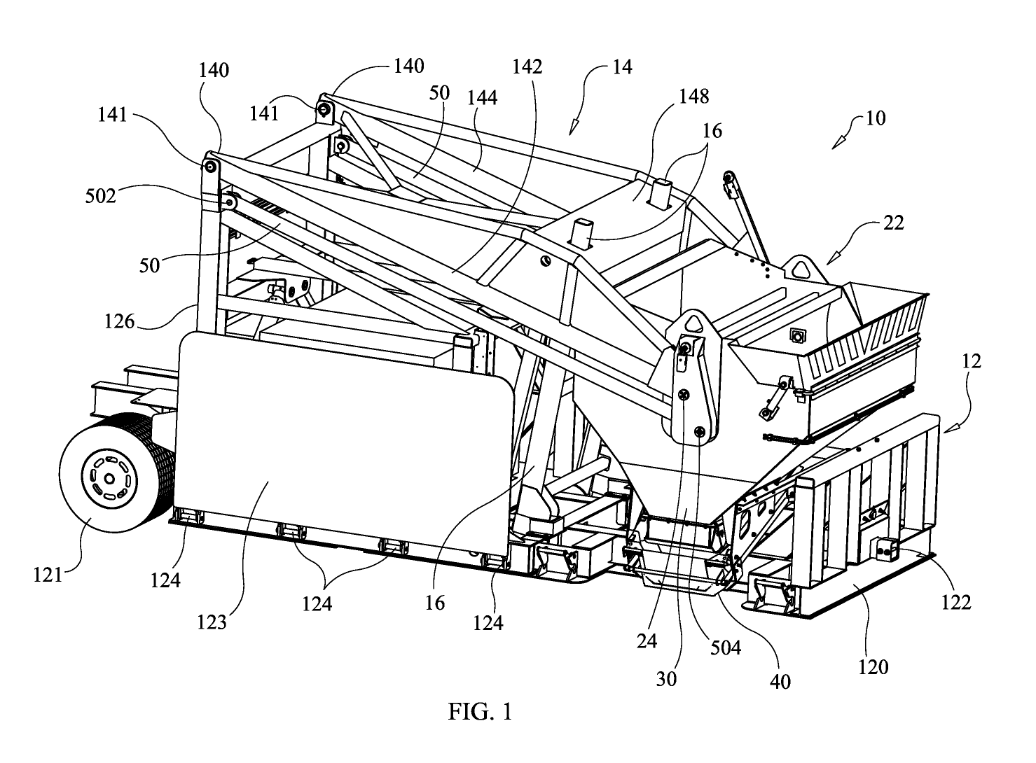

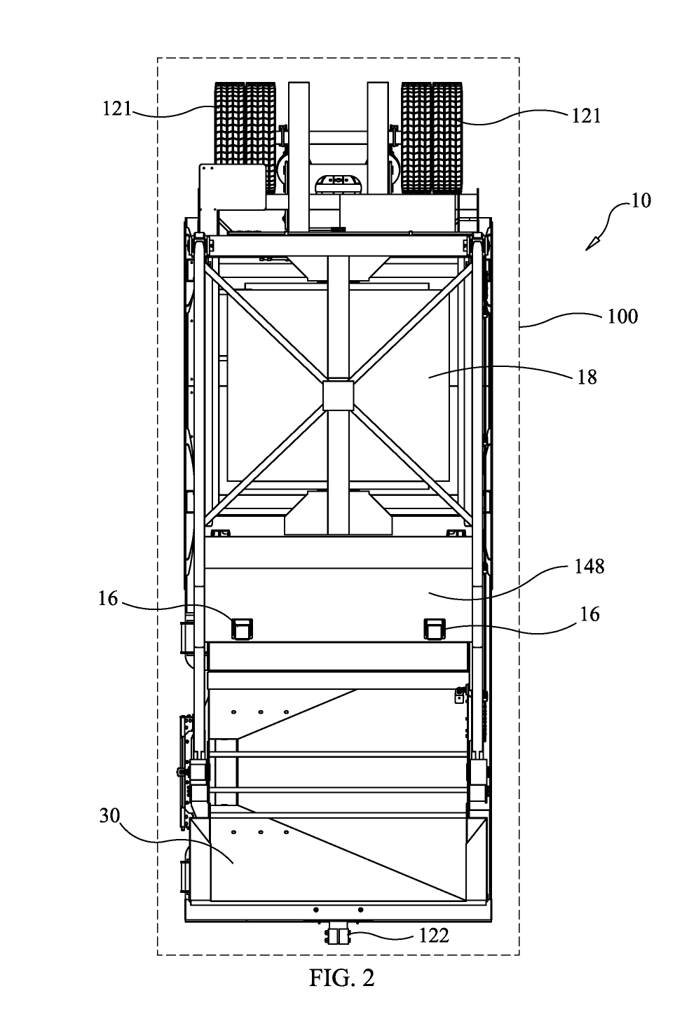

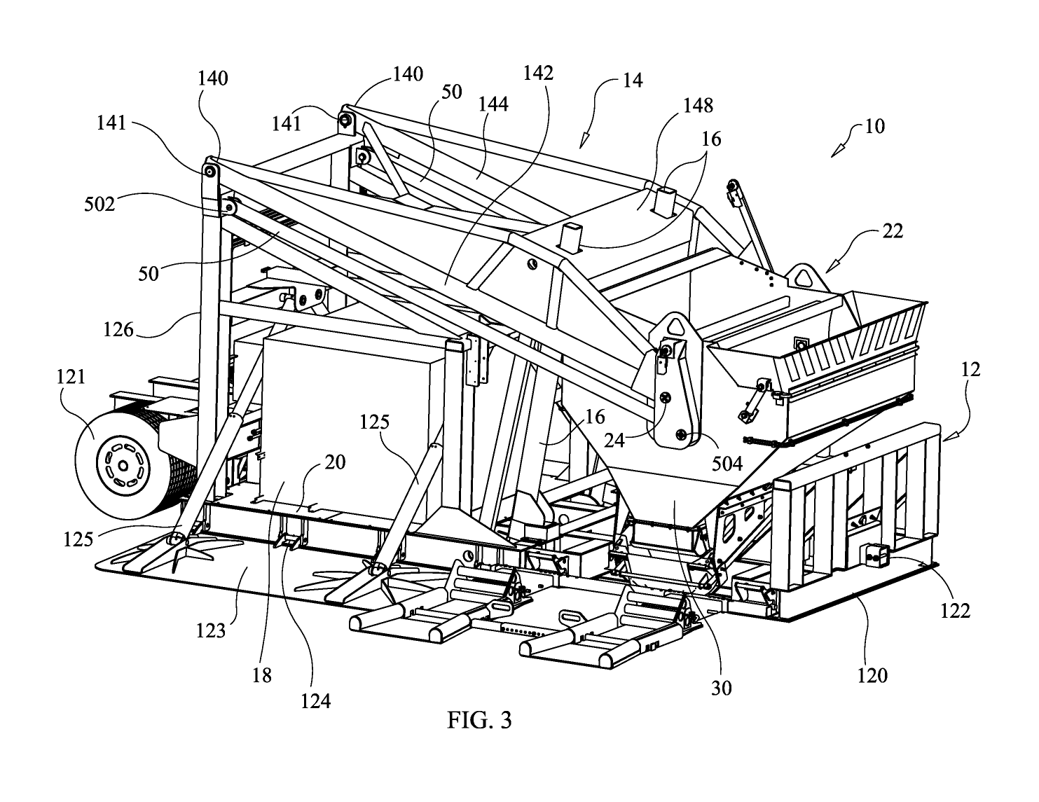

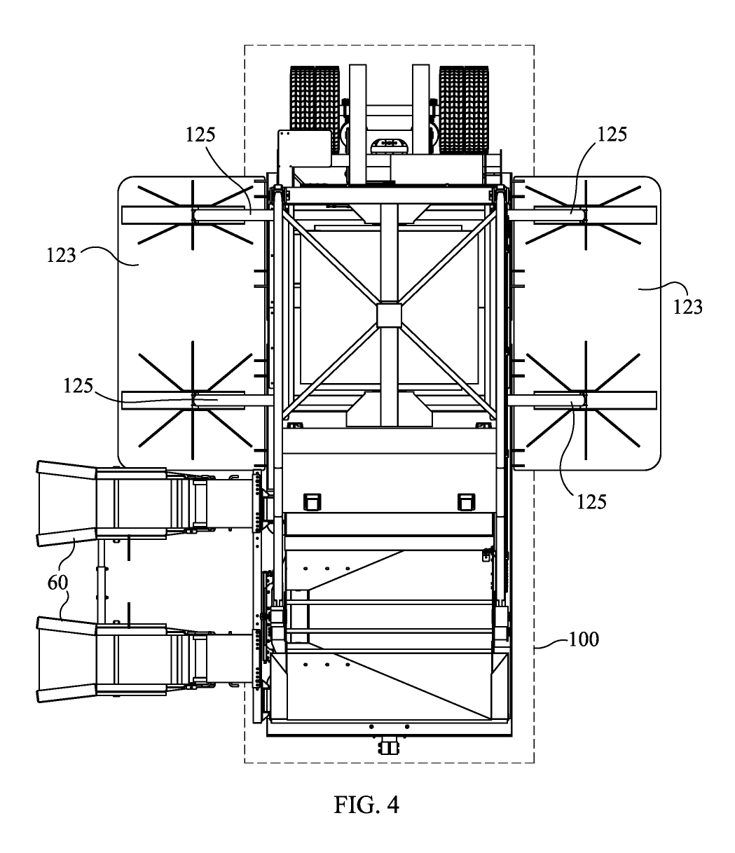

Referring now to the drawings, simultaneous reference will be made to FIGS. 1-4 where a mobile transfer station in accordance with an embodiment of the present invention is shown and is referenced generally by numeral 10. Mobile transfer station 10 will be referred to as “MTS 10” hereinafter. FIGS. 1 and 2 illustrate MTS 10 in its transport-ready configuration and FIGS. 3 and 4 illustrate MTS 10 in its site-ready configuration. By way of an illustrative example, MTS 10 will be explained for its use as a mobile concrete transfer station that facilitates the transfer of wet concrete between dump trucks and ready mix concrete trucks. Accordingly, FIGS. 1 and 2 illustrate MTS 10 configured for transport to/from a job site where the concrete transfer will occur, while FIGS. 3 and 4 illustrate MTS 10 at a job site with its stabilizer pads and wheel positioners deployed and attached, respectively, as will be explained further below. Although MTS 10 will be described for its use in a wet concrete transfer operation, it is to be understood that MTS 10 can be used to facilitate the transfer of any bulk flowable material (e.g., sand, gravel, grains, etc.) without departing from the scope of the present invention.

As will be explained later herein, a dump truck (not shown) is used to load MTS 10 with wet concrete and ready mix trucks (not shown) are used to off-load the wet concrete from MTS 10. In general, MTS 10 is transported to/near a job site and then parked at/near the job site. Dump trucks are used to transport wet concrete from a concrete plant to MTS 10, and ready mix trucks are used to transport wet concrete from MTS 10 to precise dispensing locations at the job site. In this way, readily-available and cost-efficient dump trucks can be used to provide a steady/efficient supply of wet concrete to a job site, while only a small number of less-available and more costly ready mix trucks are needed at the job site for concrete dispensing/placement.

In order to be transportable on ground surfaces such as public roadways and private job-site roadways, MTS 10 defines a footprint projectable to a ground surface that allows MTS 10 to be safely moved on roadways of interest. The footprint of MTS 10 is illustrated in FIGS. 2 and 4 and is indicated by the dashed-line box referenced by numeral 100. In FIG. 2, MTS 10 is configured in its travel-ready configuration where none of MTS 10 extends outside of footprint 100. In FIG. 4, MTS 10 is in its site-ready configuration with elements thereof extending outside of footprint 100 as will be described further below.

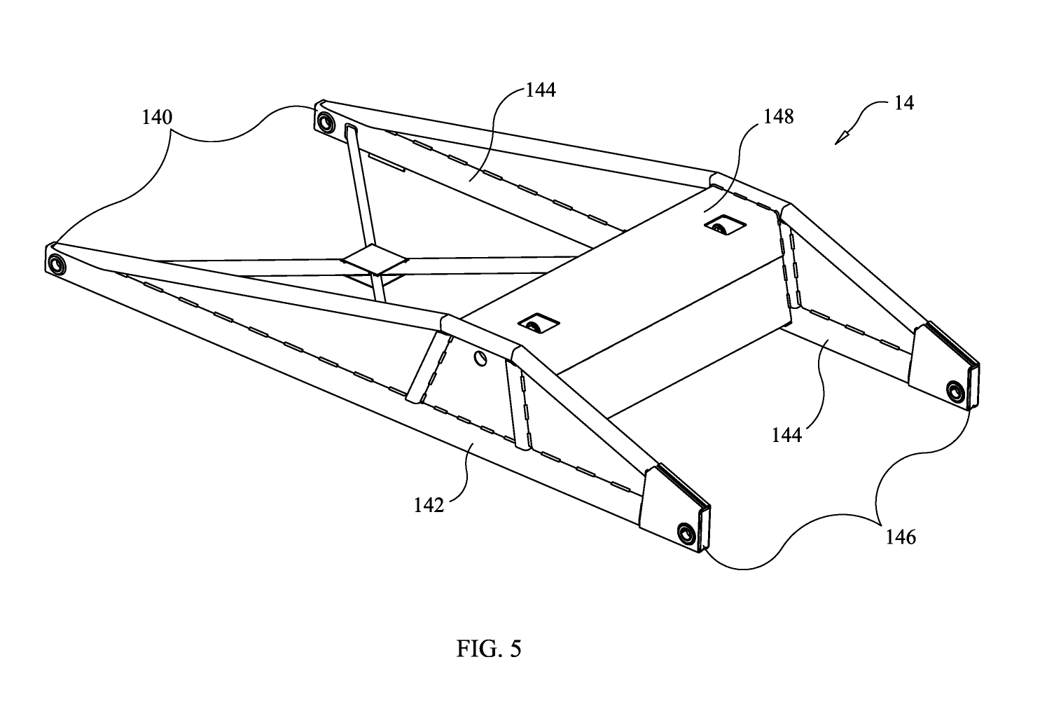

To facilitate an understanding of the present invention, the ensuing description will make additional and simultaneous reference to FIGS. 5-8 where various subassemblies of MTS 10 are shown in isolation and in different views in order to more clearly illustrate the features thereof. It is to be understood that not every feature will be visible in every view so that simultaneous reference to the figures is necessary.

MTS 10 includes a trailer 12 that can be towed/driven to a job site and stabilized for a concrete transfer operation. Trailer 12 is generally a mobile trailer that includes (among other things) a rigid trailer frame 120, wheels/tires 121 coupled to frame 120 at an aft end thereof for rolling support of trailer 12, and a tow coupling 122 coupled to frame 120 at a forward end thereof. As used herein, the forward end and aft end of trailer frame 120 are defined relative to the direction of travel of trailer 12 when it is being towed behind a tow vehicle (not shown) coupled to tow coupling 122. It is to be understood that the particular construction of trailer 12 is not a limitation of the present invention, and that trailer 12 can include additional features without departing from the scope of the present invention.

In terms of the present invention, outrigger stabilizing pads 123 are hingedly coupled (as indicated by reference numeral 124) to lateral sides of frame 120. Pads 123 are rotated about hinge 124 to a vertical position (FIGS. 1 and 2) for transport of MTS 10, and rotated about hinge 124 to a horizontal position (FIGS. 3 and 4) once MTS 10 is on site. In their horizontal position, pads 123 rest on a ground surface on both sides of MTS 10 for stability. Power cylinders 125 coupled to portions of frame 120 and pads 123 control rotation of pads 123 between their vertical and horizontal positions.

Frame 120 includes rigid supports 126 coupled to and extending vertically up from opposing lateral sides of frame 120 near the aft end of frame 120. Supports 126 can be attached to or integrated with frame 120 such that they are essentially extensions of frame 120. A hopper support 14 (shown in isolation in FIG. 5) is hingedly coupled at ends 140 thereof to the upper ends of supports 126 as indicated by reference numeral 141. Hopper support 14 is a rigid frame having opposing and parallel longitudinal sides 142 and 144 extending from respective ends 140 to opposing ends 146. Spanning and coupled to sides 142 and 144 between ends 140/146 is a lift housing 148. Pneumatic or hydraulic lifts 16 are coupled to frame 120 and to a portion of lift housing 148. Lifts 16 can be powered/controlled by power and control system(s) 18 mounted on frame 120. It is to be understood that power and control system(s) 18 can include a variety of apparatus/systems that allow the operation of MTS 10 to be fully self-supportive. Accordingly, power and control system(s) 18 can include, but is not limited to, gas generators, compressors, batteries, fuel tanks, fuel cells, controllers, etc. Power and control system(s) 18 could be mounted on a pallet 20 to simplify removal, replacement, and/or repair of system(s) 18. For clarity of illustration, wires, conduits, etc., between power and control system(s) 18 and the powered/controlled elements of MTS 10 have been omitted.

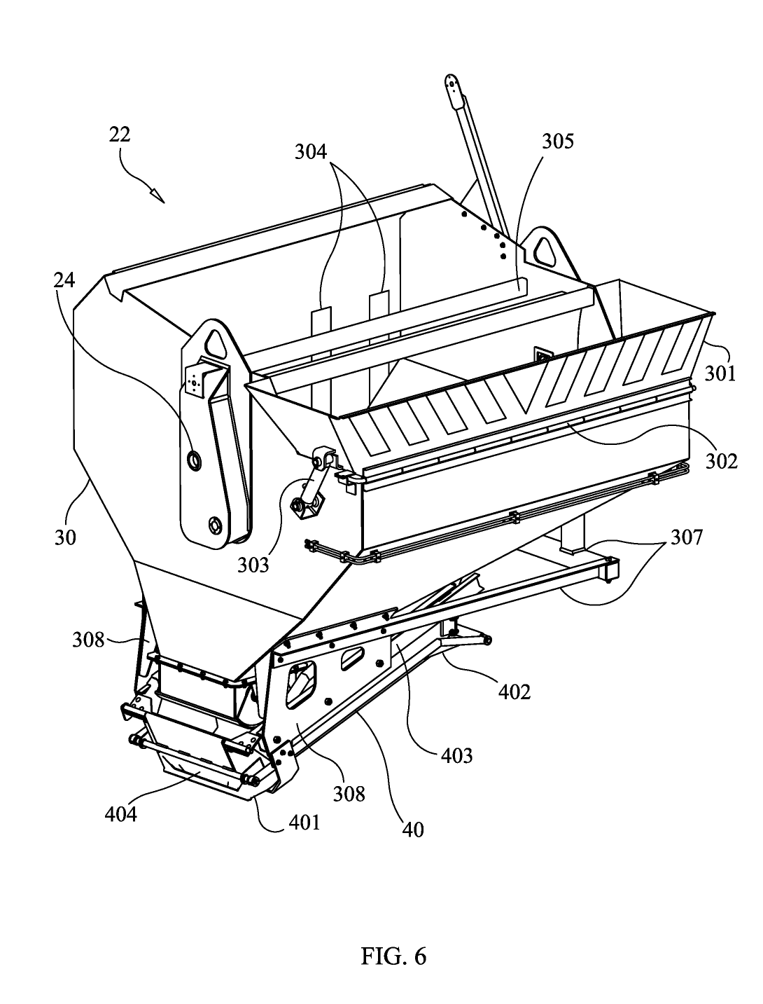

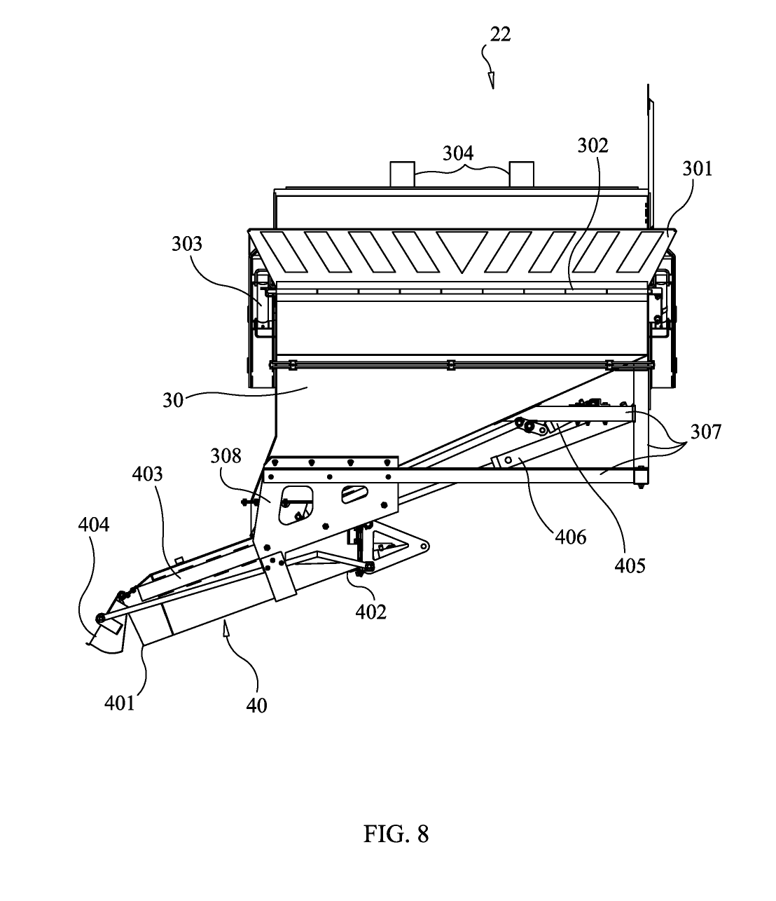

Opposing sides of a hopper and chute assembly 22 (shown in isolation in FIGS. 6 and 8) are hingedly coupled to ends 146 of hopper support 14 as indicated by reference numeral 24. Assembly 22 includes a hopper 30 and a chute 40 coupled to hopper 30. As will be explained further below, chute 40 is positioned fully under hopper 30 during a concrete-loading operation, and is extended from hopper 30 during a concrete off-loading operation to, for example, a ready mix truck.

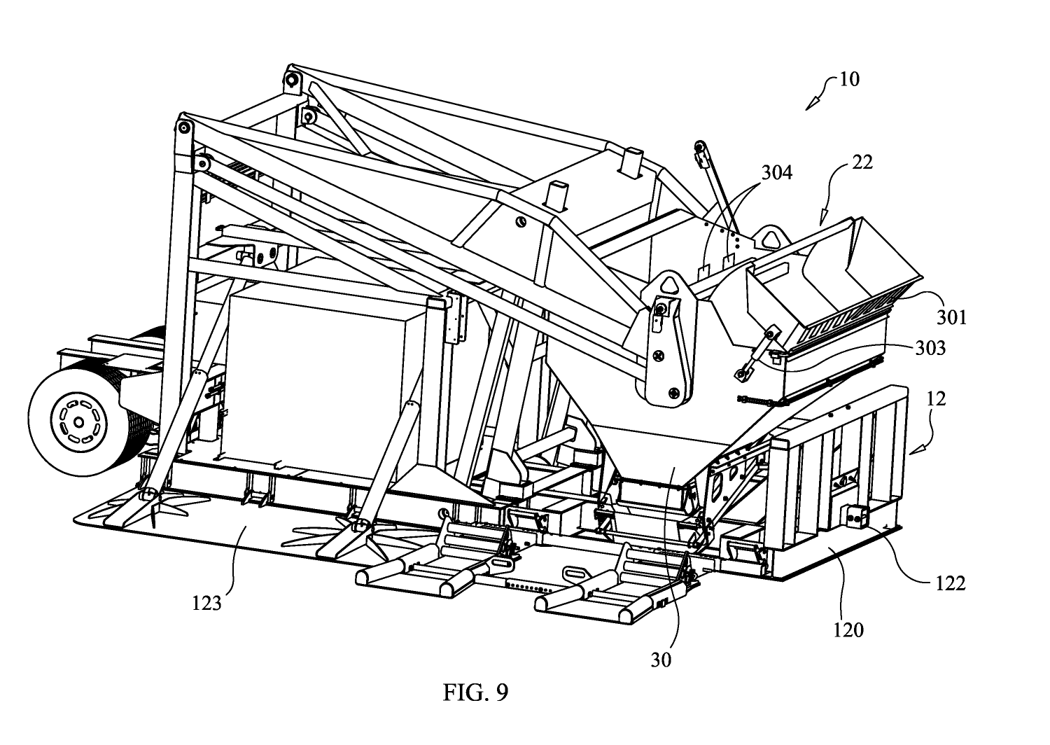

Hopper 30 is an open-top container that receives concrete from a dump truck (not shown) when MTS 10 is in its concrete-loading position. The top portion of hopper 30 adjacent to the forward end of trailer 12 can be defined by a deflector 301 that can be tilted or angled towards a dump truck (not shown) backed up the forward end of trailer 12 as shown in FIG. 9. Deflector 301 can be rotated about a hinge 302 by an electric, hydraulic, or pneumatic drive 303. When deflector 301 is rotated to its tilted position as shown in FIG. 9, the top opening of hopper 30 is positioned to receive the angled (dumping) bed of a dump truck during a concrete-loading operation. Hopper 30 can also have one or more vibrators 304 supported on a cross-rail 305 at the open top of hopper 30. Vibrators 304 extend into hopper 30 and, when vibrating, keep concrete in hopper 30 in a more fluid state to facilitate the concrete off-loading operation. One side of the bottom of hopper 30 has a sealable opening formed therein. In the illustrated example, the sealable opening in hopper 30 is defined by a clam shell type of valve 306 provided at one bottom side of hopper 30. It is to be understood that other types of valve/openings could be used in the bottom of hopper 30 without departing from the scope of the present invention. The sides and bottom of hopper 30 can be sloped towards valve 306 as illustrated.

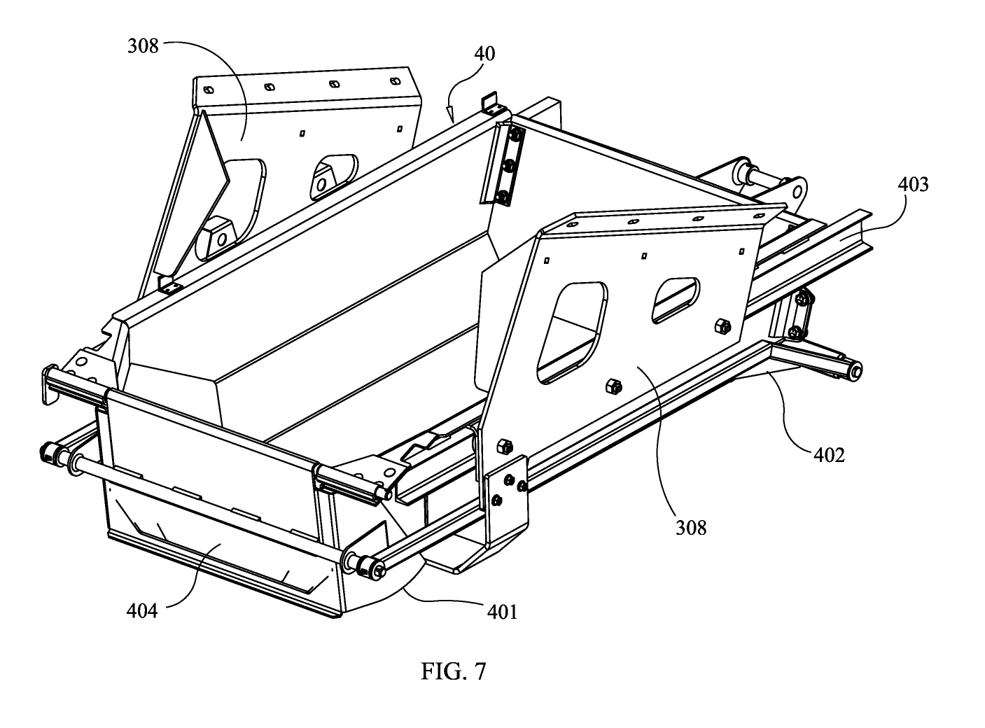

Chute 40 (shown in isolation in FIG. 7) is coupled to the bottom of hopper 30. In general, chute 40 is disposed at an angle and is slidably mounted on hopper 30 such that some portion of chute 40 is under valve 306 at all times. The angular disposition of chute 40 is such that it has a lower end 401 and an upper end 402 such that upper end 402 is always above lower end 401. During a concrete loading operation, both lower end 401 and upper end 402 of chute 40 remain within the above-described footprint 100 of MTS 10. However, during a concrete off-loading operation, chute 40 is extended to the side of hopper 30 such that lower end 401 of chute 40 extends beyond footprint 100 of MTS 10. In its extended position, lower end 401 of chute 40 is the discharge point for wet concrete flowing along chute 40 when valve 306 in hopper 30 is opened over chute 40. To support sliding movement of chute 40 beneath hopper 30, side flanges 308 rigidly coupled to supports 307 of hopper 30 provide sliding support of rails 403 defined along the sides of chute 40. Chute 40 has a pivoting door 404 at its lower end 401 that can be opened/closed by an electric, hydraulic, or pneumatic drive 405 coupled to supports 307. Chute 40 is moved along flanges 308 by an electric, hydraulic, or pneumatic drive 406 coupled to supports 307.

An operational sequence of MTS 10 will now be explained with reference to FIGS. 9-13 where it is assumed that MTS 10 has been transported/towed to a site and is ready to receive and then off-load a flowable material such as concrete. That is, it is assumed in this sequence of figures that the towing vehicle (not shown) has been uncoupled from tow coupling 122 at the forward end of trailer 12. For clarity of illustration, only those reference numerals relevant to the description of each figure are shown. In FIG. 9, MTS 10 is illustrated with its pads 123 rotated to their horizontal position to stabilize MTS 10 on a ground surface. Hopper assembly 22 is in its lowered position and deflector 301 is tilted towards the forward end of trailer 12 as controlled by drive 303. In this position, a dump truck (not shown) filled with wet concrete can back up to MTS 10 and dump its load into hopper 30 at tilted deflector 301. Hopper 30 can be sized to receive approximately one dump truck load of wet concrete.

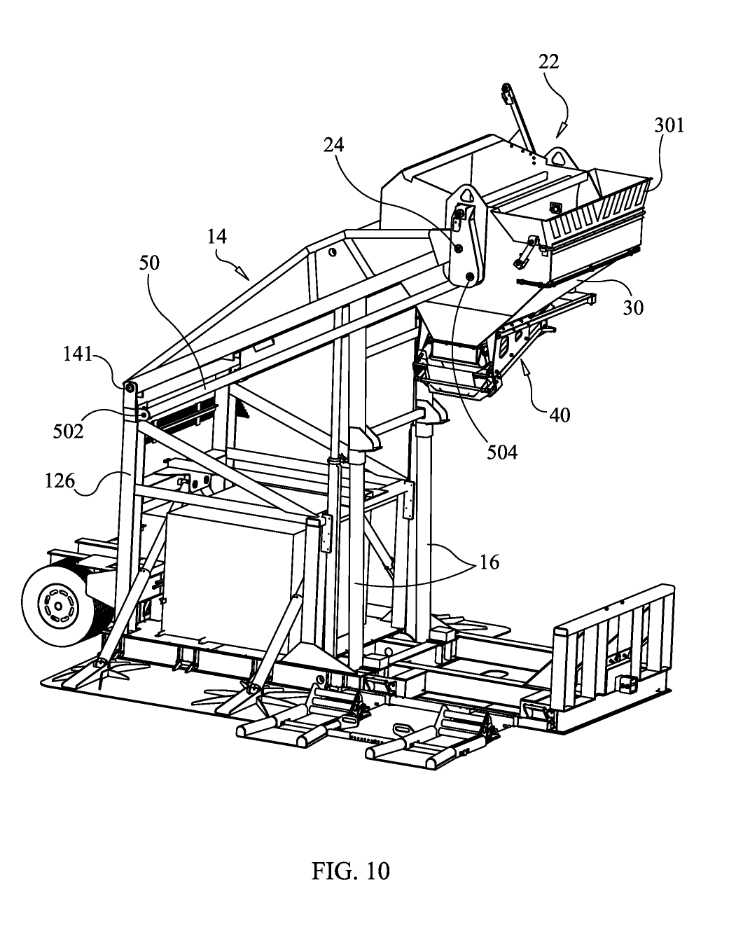

In preparation for a concrete off-loading operation, deflector 301 is rotated back to its original position and hopper assembly 22 is raised up from trailer 12 by means of lifts 16 as shown in FIG. 10. In order to stabilize a filled hopper 30 during such movement, additional support rods 50 can be included in MTS 10. More specifically, each support rod is of rigid construction and is hingedly coupled on one end to one of supports 126 at 502 and hingedly coupled on the other end thereof to a side of hopper assembly 22 as indicated at 504. Each of rods 50 is parallel to a respective one of sides 142 and 144 of hopper support 14 with the distance between each rod 50 and the respective one of sides 142 and 144 being equal.

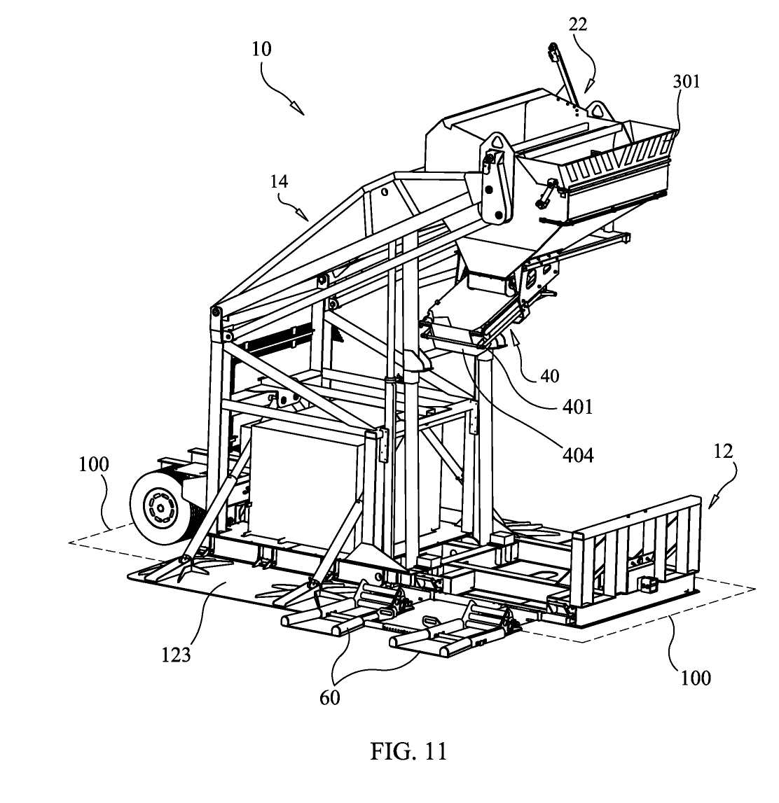

Referring now to FIG. 11, chute 40 is extended out from hopper assembly 22 such that its lower end 401 with pivoting door 404 extends beyond footprint 100 at a lateral side of trailer 12. Additionally, wheel positioning chocks 60 can be attached to trailer 12 to help align a ready mix truck (not shown) with pivoting door 404 for a concrete off-loading operation.

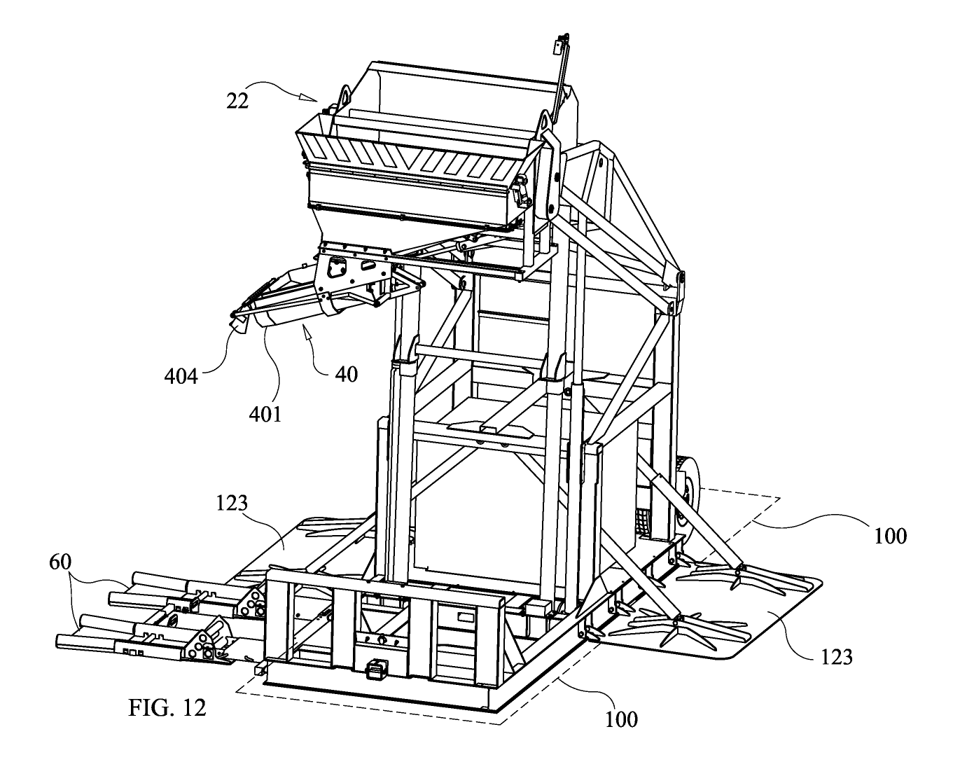

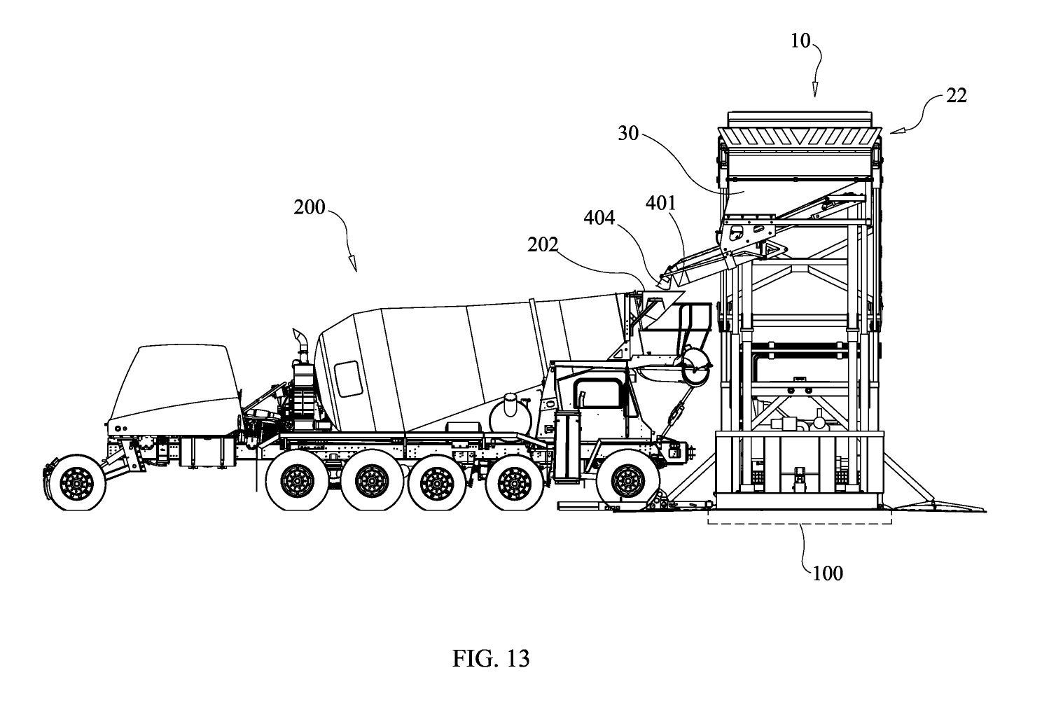

Referring simultaneously now to FIGS. 12 and 13, MTS 10 is illustrated with its pivoting door 404 opened to support the off-loading of concrete. In FIG. 12, MTS 10 is illustrated without a ready mix truck adjacent thereto, while FIG. 13 illustrates a ready mix truck 200 with its loading port 202 aligned with lower end 401 of extended chute 40. From this position, the hopper's valve 306 (see FIGS. 6 and 11) can be opened and concrete can be off-loaded from hopper 30 into ready mix truck 200. Vibrators 304 can be operated when hopper 30 contains wet concrete to improve the flow properties of the wet concrete as it leaves hopper 30 and flows along chute 40. It is to be understood that concrete could also be off-loaded to a concrete pump, a concrete conveyor, or even a hole in the ground, without departing from the scope of the present invention.

The advantages of the present invention are numerous. The mobile transfer station provides for efficient use of dump trucks for the delivery of bulk flowable material to a specific site where the material is to be re-dispensed. In terms of concrete transfer operations, the present invention facilitates efficient and cost-effective use of ready mix trucks for the task of dispensing wet concrete at a job site. By transferring wet concrete to ready mix trucks at a job site, adjustments to the concrete can be readily made prior to concrete placement thereby avoiding the problems associated with placing dump-truck-delivered concrete. The transfer station is readily transported and can be completely self-contained and self-supportive.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A mobile transfer station for flowable material, comprising:
a mobile frame defining a footprint;
a hopper support having a first end and a second end, said first end pivotally coupled to said mobile frame;
an open-top hopper pivotally coupled to said second end of said hopper support;
a valve disposed in a lower portion of said hopper;
a chute slidably coupled to said hopper and disposed beneath said valve, said chute having an upper end and a lower end wherein said upper end is maintained at a height that is greater than a height of said lower end, said chute being extendable from a first position to a second position wherein said lower end is within said footprint when said chute is in said first position, and wherein said lower end is outside said footprint when said chute is in said second position; and
a lift mechanism coupled to said mobile frame and a portion of said hopper support between said first end and said second end thereof for raising and lowering said hopper relative to said mobile frame.

2. A mobile transfer station as in claim 1, further comprising vibrating elements coupled to said hopper and extending into said hopper.

3. A mobile transfer station as in claim 1, wherein said mobile frame comprises a trailer having a forward end adapted to be coupled to a towing vehicle.

4. A mobile transfer station as in claim 3, wherein said hopper is adjacent to said forward end.

5. A mobile transfer station as in claim 4, wherein a top portion of said hopper along a side thereof adjacent to said forward end is tiltable away from said hopper.

6. A mobile transfer station as in claim 1,
wherein said mobile frame is adapted for movement along a ground surface,
wherein said footprint defines a forward end, an aft end, and two lateral sides relative to said movement, and
wherein said second end of said chute extends beyond one of said two lateral sides when said chute in in said second position.

7. A mobile transfer station as in claim 1, further comprising pads pivotally coupled to said mobile frame for one of a vertical position against said mobile frame and a horizontal position adjacent to said mobile frame.

8. A mobile transfer station as in claim 1, further comprising wheel positioners coupled to said mobile frame and adapted to align a truck with said second end of said chute in said second position.

9. A mobile transfer station for flowable material, comprising:
a mobile frame defining a footprint;
a hopper support having parallel longitudinal sides, each of said longitudinal sides terminating in a first end and a second end, each said first end pivotally coupled to said mobile frame;
an open-top hopper pivotally coupled to each said second end of said longitudinal sides;
a first rod pivotally coupled to said mobile frame and to said hopper, said first rod being parallel to one of said longitudinal sides of said hopper support;
a second rod pivotally coupled to said mobile frame and to said hopper, said second rod being parallel to another of said longitudinal sides of said hopper support;
a valve disposed in a lower portion of said hopper;
a chute slidably coupled to said hopper and disposed beneath said valve, said chute having an upper end and a lower end wherein said upper end is maintained at a height that is greater than a height of said lower end, said chute being extendable from a first position to a second position wherein said lower end is within said footprint when said chute is in said first position, and wherein said lower end is outside said footprint when said chute is in said second position; and
a lift mechanism coupled to said mobile frame and a portion of said hopper support between said first end and said second end thereof for raising and lowering said hopper relative to said mobile frame.

10. A mobile transfer station as in claim 9, further comprising vibrating elements coupled to said hopper and extending into said hopper.

11. A mobile transfer station as in claim 9, wherein said mobile frame comprises a trailer having a forward end adapted to be coupled to a towing vehicle.

12. A mobile transfer station as in claim 11, wherein said hopper is adjacent to said forward end.

13. A mobile transfer station as in claim 12, wherein a top portion of said hopper along a side thereof adjacent to said forward end is tiltable away from said hopper.

14. A mobile transfer station as in claim 9,
wherein said mobile frame is adapted for movement along a ground surface,
wherein said footprint defines a forward end, an aft end, and two lateral sides relative to said movement, and
wherein said second end of said chute extends beyond one of said two lateral sides when said chute in in said second position.

15. A mobile transfer station as in claim 9, further comprising pads pivotally coupled to said mobile frame for one of a vertical position against said mobile frame and a horizontal position adjacent to said mobile frame.

16. A mobile transfer station as in claim 9, further comprising wheel positioners coupled to said mobile frame and adapted to align a truck with said second end of said chute in said second position.

17. A mobile transfer station as in claim 9, wherein said first rod and said second rod are the same size, and wherein a distance between said first rod and said one of said longitudinal sides is equal to a distance between said second rod and said another of said longitudinal sides.

18. A mobile transfer station for flowable material, comprising:
a mobile trailer frame having a towing end adapted to be coupled to a tow vehicle for towing thereby on a ground surface, said mobile trailer frame defining a footprint on the ground surface;
a hopper support having a first end and a second end, said first end pivotally coupled to said mobile trailer frame;
a hopper assembly having (i) an open-top hopper pivotally coupled to said second end of said hopper support, (ii) a valve disposed in a bottom of said hopper, and (iii) a chute slidably coupled to said hopper and disposed beneath said valve, said chute having an upper end and a lower end wherein said upper end is maintained at a height that is greater than a height of said lower end, said chute being extendable from a first position to a second position wherein said lower end is within said footprint of said mobile trailer frame when said chute is in said first position, and wherein said lower end is outside said footprint of said mobile trailer frame when said chute is in said second position; and
a lift mechanism coupled to said mobile trailer frame and a portion of said hopper support between said first end and said second end thereof for raising and lowering said hopper assembly between a lowered position adjacent said towing end of said mobile trailer frame and a raised position at a height above said towing end of said mobile trailer frame.

19. A mobile transfer station as in claim 18, further comprising vibrating elements coupled to said hopper and extending into said hopper.

20. A mobile transfer station as in claim 18, wherein a top portion of said hopper along a side thereof adjacent to said towing end is tiltable away from said hopper.

21. A mobile transfer station as in claim 18, wherein said second end of said chute extends beyond a lateral side of said mobile trailer frame when said chute in in said second position.

22. A mobile transfer station as in claim 18, further comprising pads pivotally coupled to lateral sides of said mobile trailer frame for one of a vertical position against said mobile trailer frame and a horizontal position adjacent to said mobile trailer frame and outside of said footprint thereof.

23. A mobile transfer station as in claim 18, further comprising wheel positioners coupled to said mobile frame and adapted to align a truck with said second end of said chute in said second position.
